(19) United States
(12) Patent Application Publication
(10) Pub. No.: US 2026/0001206 A1
(43) Pub. Date: Jan. 1, 2026

(54) SYSTEMS AND METHODS FOR POWER TOOLS WITH ENHANCED MOTOR THERMAL PROTECTION

(71) Applicant: Milwaukee Electric Tool Corporation, Brookfield, WI (US)

(72) Inventor: Jesse Gibb, Brookfield, WI (US)

(21) Appl. No.: 19/249,942

(22) Filed: Jun. 25, 2025

Related U.S. Application Data
(60) Provisional application No. 63/664,568, filed on Jun. 26, 2024.
(60) Provisional application No. 63/665,198, filed on Jun. 27, 2024.

(51) Int. Cl. B25F 5/00; H02P 23/14; H02P 27/06; H02P 29/68

(52) U.S. Cl. CPC B25F 5/00; H02P 23/14; H02P 27/06; H02P 29/68

(57) ABSTRACT

A power tool is provided including a motor, an inverter that drives the motor, a sensor configured to sense a variable indicative of a motor temperature of the motor, a trigger, a power source, and a controller in communication with the inverter, the sensor, the trigger, and the power source. The controller is configured to apply power from the power source to the inverter to drive the motor at a requested effort level based on an amount of travel of the trigger when the trigger is depressed. The controller is further configured to reduce the requested effort level to the inverter when the motor temperature reaches a first temperature threshold, and shut down the motor when the motor temperature reaches a second temperature threshold.

### RELATED APPLICATIONS

This application claims priority under 35 U.S.C. § 119 to United States Provisional Patent Application No. 63/664,568 filed on June 26, 2024 and United States Provisional Patent Application No. 63/665,198 filed on June 27, 2024, the entire contents of which are incorporated herein by reference.

### BACKGROUND

Cordless, e.g., battery-powered, power tools generally include a motor configured to rotate in response to user input, such as actuation of a trigger, in order to drive a tool bit. A motor that has been run too long or too hard can overheat in some cases, which can cause damage to the motor and its mechanical parts. Some power tools include thermal protectors, which attempt to prevent the motor from overheating by shutting down motor operation once a set temperature is reached.

### SUMMARY

Some embodiments provide a power tool including a motor, an inverter that drives the motor, a sensor configured to sense a variable indicative of a motor temperature of the motor, a trigger, a power source, and a controller in communication with the inverter, the sensor, the trigger, and the power source. The controller is configured to apply power from the power source to the inverter to drive the motor at a requested effort level based on an amount of travel of the trigger when the trigger is depressed. The controller is further configured to reduce the requested effort level to the inverter when the motor temperature reaches a first temperature threshold, and shut down the motor when the motor temperature reaches a second temperature threshold.

Some embodiments a method of operating a power tool. The method includes applying power from a power source to an inverter to drive a motor at a requested effort level based on an amount of travel of a trigger when the trigger is depressed. The method also includes reducing the requested effort level to the inverter when a motor temperature of the motor reaches a first temperature threshold, and shutting down the motor when the motor temperature reaches a second temperature threshold.

Some embodiments provide a method of operating a power tool. The method includes applying power from a power source to an inverter to drive a motor at a requested effort level based on an amount of travel of a trigger when the trigger is depressed. The method also includes determining a minimum effort level based on an input current to the motor, comparing the requested effort level to the minimum effort level, and reducing the requested effort level to the inverter when a motor temperature of the motor reaches a first temperature threshold and the requested effort level is greater than the minimum effort level.

### DESCRIPTION OF THE DRAWINGS

FIG. 1 is a schematic view of an example power tool.

FIG. 2 is an isometric view of an example rotary hammer.

FIG. 3 is a partial cross-sectional view of the rotary hammer of FIG. 2.

FIG. 4 is a graph illustrating temperature, current, and motor speed over time, including actual measured values and predicted values output from a thermal model.

FIG. 5 is another graph illustrating temperature, current, and motor speed over time, including actual measured values and predicted values output from a thermal model.

FIG. 6 is an example method of operating a power tool with motor thermal protection.

FIG. 7 is another example method of operating a power tool with motor thermal protection.

FIG. 8 is an example map illustrating averaged current in relation to minimum inverter effort reduction limits for use with the method of FIG. 7.

FIG. 9 s an example proportional-integral control loop for use with the method of FIG. 6 or FIG. 7.

FIG. 10 is another schematic view of an example power tool.

### DETAILED DESCRIPTION

The following discussion is presented to enable a person skilled in the art to make and use embodiments of the disclosed technology. Given the benefit of this disclosure, various modifications to the illustrated embodiments will be readily apparent to those skilled in the art, and the principles herein can be applied to other embodiments and applications without departing from embodiments of the disclosed technology. Thus, embodiments of the disclosed technology are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the disclosed technology. Skilled artisans will recognize the examples provided herein have many useful alternatives and fall within the scope of embodiments of the disclosed technology.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of "including," "comprising," or "having" and variations thereof herein is meant to encompass the items listed thereafter and equivalents thereof as well as additional items. Unless specified or limited otherwise, the terms "mounted," "connected," "supported," and "coupled" and variations thereof are used broadly and encompass both direct and indirect mountings, connections, supports, and couplings. Further, "connected" and "coupled" are not restricted to physical or mechanical connections or couplings.

Generally, power tools are configured to shut down when a set temperature is reached in order to attempt to prevent motor overheating and associated tool damage. Such shutdowns can be frustrating for users and, thus, it would be beneficial to extend the use of such tools while still providing overheat protection. The present disclosure provides such a benefit by implementing enhanced motor heat protection for power tools. More specifically, the present disclosure provides systems and methods to reduce power applied to a motor inverter prior to motor shutdown in an attempt to extend tool use without overheating. That is, the present systems and methods continue motor operation, though at a reduced power level, in an attempt to reduce thermal output prior to a motor shutdown temperature being reached.

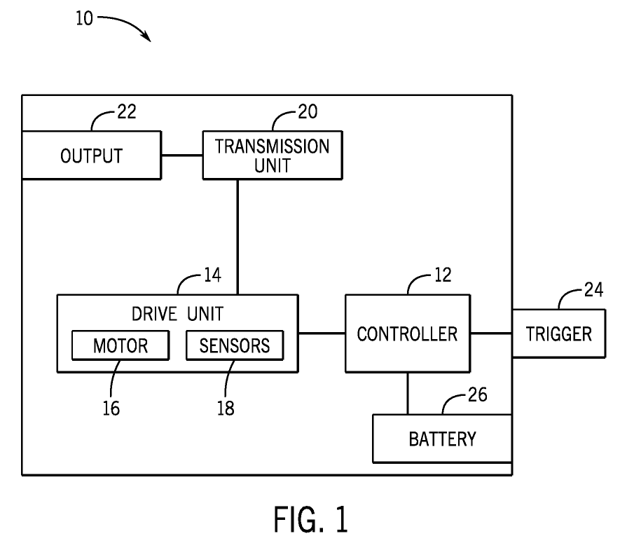

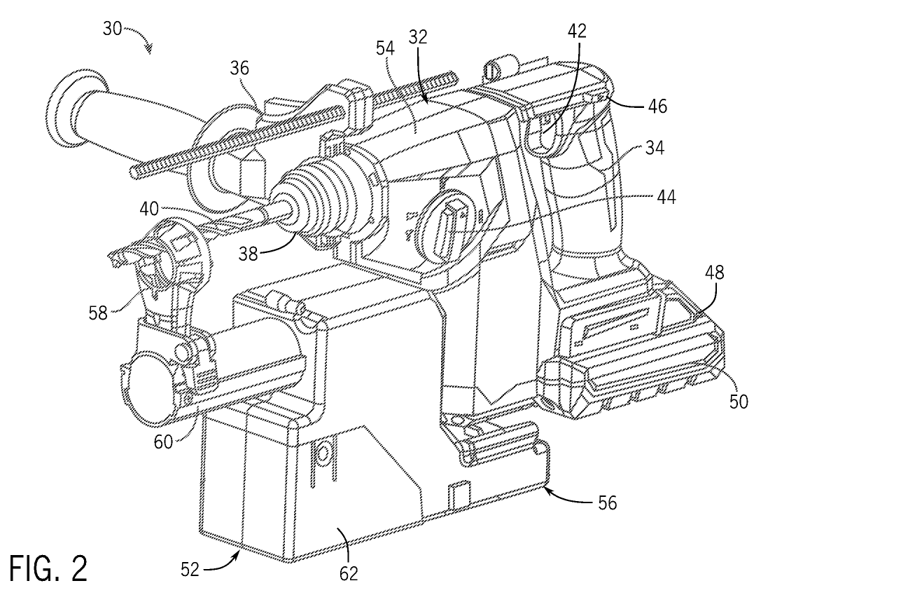

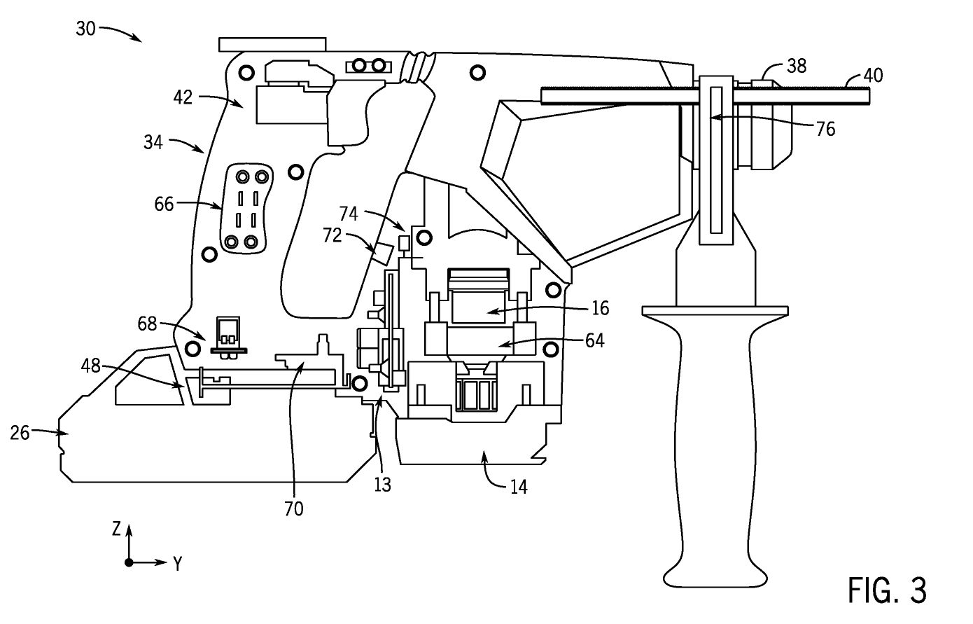

Generally, examples of the disclosed technology can be implemented on any variety of power tools including, but not limited to, rotary hammers, chisel hammers, cutters, grinders, ratchets, sanders, drills, drivers, staplers, saws, dust extractors, among others. In this regard, FIG. 1 provides a general schematic diagram of an example power tool and, while FIGS. 2 and 3 illustrate additional details of an example rotary hammer, it should be noted that any of the description related to FIGS. 2 and 3 can be applied to other power tools.

Accordingly, FIG. 1 illustrates a schematic diagram of an example power tool 10 according to some implementations. As shown in , the power tool 10 can include a controller 12, a drive unit 14 including a motor 16 and one or more sensors 18, a transmission unit 20, an output such as a tool head or tool bit 22, a user input, such as a trigger 24, and a power source, such as a battery 26. Generally, the controller 12 selectively controls the drive unit 14, specifically, the motor 16, in response to a user depressing the trigger 42. The motor 16 is powered by the battery 26, e.g., a DC power source (though the motor 16 may instead be powered by an AC power source in some implementations). The motor 16 is configured to produce, or generate, torque as controlled by the controller 12, and the transmission unit 20 is configured to receive torque from the motor 16 and drive the output 22. For example, torque from the motor 16 can be transferred to the output 22 to reciprocate or rotate a tool bit. Furthermore, the controller 12 can receive inputs from the sensors 18 to determine an indication of motor temperature (e.g., directly or indirectly) and further control the motor 16 based on this temperature indication, as further described below. In some implementations, the controller 12 is part of the drive unit 14.

As a specific power tool example, illustrate an example rotary hammer 30. As shown in , the rotary hammer 30 can include a housing 32, a handle 34, a removable secondary handle 36, an output chuck 38 configured to hold a tool bit 40, user inputs including a trigger 42, a mode selector 44, and a forward/reverse switch 46, a battery receptacle 48 to hold a removable battery 50, and a dust extractor assembly 52.

Referring to FIG. 2 , the housing 32 can include a transmission unit housing 54 that accommodates a transmission unit (such as transmission unit 20 shown in FIG. 1) and a drive unit 56 housing that accommodates a drive unit 14 (shown in FIG. 3 ). As described above with respect to FIG. 1 , the drive unit 14 is configured to produce, or generate, torque, and the transmission unit 20 is configured to receive torque from the drive unit 14 and reciprocate and/or rotate the tool bit 40. The specific output of the driven tool bit 40 can depend on the user inputs, e.g., the mode selector switch 44 for selecting drilling or rotary hammering output, the forward/reverse switch 46 for forward or reverse rotation, and the trigger 42 for start, stop, and speed control. The rotary hammer 30 may be powered by the battery 50, which can be removably received within the battery receptacle 48. Furthermore, the dust extractor assembly 52 may be permanently or removably coupled to the housing 32 and configured to collect dust and other debris during operation. For example, the dust extractor assembly 52 can include a suction head 58 adjacent the tool bit 40, a suction tube 60, and an extractor housing 62.

Referring now to FIG. 3, some internal components of the rotary hammer 30 are illustrated (with other components hidden for ease of viewing and discussion). For example, FIG. 3 illustrates the drive unit 14 including a motor 16, a printed circuit board assembly (PCBA) 13 (e.g., which includes a controller 12 mounted thereon), and a sensor board 64. Additionally, the rotary hammer 30 can include a fuse board 66, a capacitor board 68, a battery terminal 70, auto- stop light-emitting diode (LED) 72 with an LED connection 74, and additional LEDs 76 (or other light sources) adjacent the output chuck 38.

As shown in FIG. 3, the PCBA 13 can be positioned within the drive unit 14 adjacent to the battery receptacle 48 and can include components configured to receive power from the battery 26 to control operation of the motor 16. For example, the PCBA 13 can include the controller 12, such as a microcontroller, processor, or dedicated integrated circuit (not shown), configured to execute control functions of the rotary hammer 30 and to be in communication with an inverter (not shown in FIG. 3), sensors (e.g., sensors 18 shown in FIG. 1), the trigger 42, and the power source 50. Generally, the terms controller, PCBA, microcontroller, microcontroller unit (MCU), or processor may be used interchangeably herein. Additionally, in some implementations, such control functions can be written in memory on the PCBA 13 (e.g., stored as instructions on the memory, such as a non-transitory computer-readable medium) or, more specifically, in firmware, and executed by the controller 12.

The motor 16 can be a brushless direct current ("BLDC") motor and is configured to rotate under control of the controller 12 in response to user input, such as actuation of the trigger 24. For example, the controller 12 can apply power to an inverter of the motor 16 based on an amount of trigger travel. As a first example, a full (i.e., 100%) trigger pull results in the controller 12 applying 100% power to the inverter and a 50% trigger pull results in the controller 12 applying 50% power to the inverter. However, power, or requested effort, may not be directly proportional to trigger travel in some implementations but, rather, linked to trigger travel in some manner. In another example, a full (i.e., 100%) trigger pull results in the controller 12 applying power to the inverter to achieve a maximum (100%) speed. In such implementations, the controller 12 can provide closed loop speed control, where trigger travel percentage is converted to a desired speed, which then is converted to a requested effort that is calculated via a proportional-integral (PI) loop. More specifically, in such implementations, trigger travel can be mapped to a percentage (e.g., via a spline). That mapped percentage can be multiplied by a speed range of the power tool 10 (e.g., the speed range being equal to a maximum RPM minus a minimum RPM), and a desired speed may be equal to the mapped percentage times the speed range plus the minimum RPM. The desired speed can then be fed into a PI loop with the current speed to generate a new requested effort to the inverter.

The controller 12 can further control the motor 16 based on sensor input. More specifically, in some implementations, the rotary hammer 30 can include one or more sensors 18, such as a thermistor, rotor position sensors, and a current sensor, among others. For example, the thermistor can provide temperature feedback to the controller 12 indicative of a temperature of the motor 16, such as a temperature of motor coils, a temperature within the drive unit 14, or a temperature elsewhere adjacent the motor 16. The position sensors, such as hall sensors, can provide feedback to the controller 12 indicative of motor speed (e.g., in rotations per minute, RPM) based on motor rotor position. The current sensors can provide feedback to the controller 12 indicative of motor current. In some implementations, one or more of these sensors 18 can be located in the drive unit 14 on the sensor board 64 (e.g., a hall board). However, in other implementations, the sensors 18 can be positioned at other locations, such as directly on coils of the motor 16, or elsewhere.

In some implementations, motor temperature can be determined directly from a thermistor positioned on coils of the motor 16. In other implementations, such as when the thermistor is positioned on the sensor board 64 in the drive unit 14, the motor temperature can be estimated using a thermal model that receives inputs from the thermistor, the position sensors, and the current sensors. In one specific example, the thermal model can be a machine learning-based algorithm that outputs a predicted motor temperature based on weighted inputs from the thermistor, the position sensors, and the current sensors.

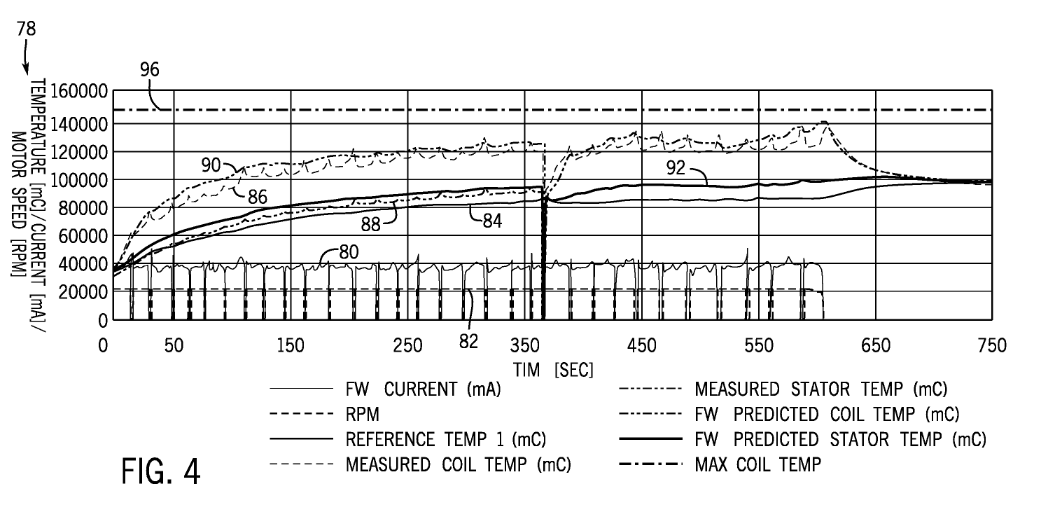

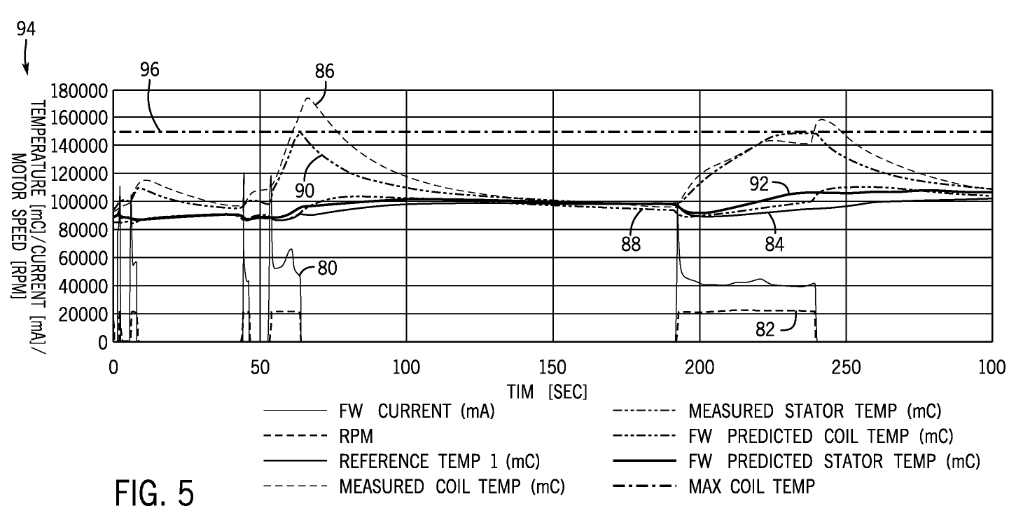

For example, FIG. 4 illustrates a graph 78 of temperature, current, and motor speed over time, showing how such a thermal model can track actual motor coil temperatures. That is, FIG. 4 illustrates input current 80 (e.g., from a current sensor), motor RPM 82 (e.g., from hall sensors), reference temperature 84 (e.g., from a thermistor on the sensor board 64), a measured motor coil temperature 86, a measured stator temperature 88, a predicted motor coil temperature 90 (i.e., output from the thermal model using the input current, the motor RPM, and the reference temperature), and a predicted stator temperature 92 (i.e., output from the thermal model using the input current, the motor RPM, and the reference temperature). Furthermore, FIG. 5 illustrates another graph 94 of temperature, current, and motor speed over time during a motor over-use case. In particular, as shown in FIG. 5, the motor 16 is over-used such that motor coil temperature, both actual temperature 86 and predicted temperature 90, reach or exceed a maximum coil temperature 96.

In some implementations, the power tool 10 (or rotary hammer 30) includes a thermal protection mechanism that automatically shuts down the motor once a maximum temperature threshold is reached (e.g., at or before the maximum coil temperature 96) to prevent the motor 16 from overheating. According to some implementations, an additional, enhanced thermal protection method can be provided to prevent the motor 16 from reaching the maximum temperature threshold or prolong motor use before the maximum temperature threshold is reached.

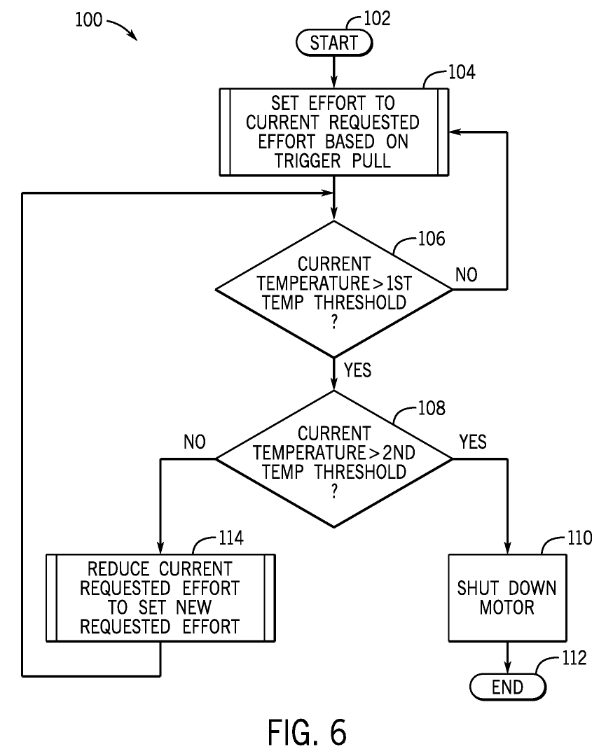

That is, according to some implementations, a power tool 10 (such as a rotary hammer 30) can dynamically adjust the power to the motor 16, overriding the user input, based on motor temperature to extend motor use prior to overheating. For example, FIG. 6 illustrates an example general method 100 of such operation according to some implementations. As shown in FIG. 6, the method 100 is started (step 102), current requested motor effort is set (step 104), and a determination is made whether the current temperature is greater than a first temperature threshold (step 106). If no, the method proceeds back to step 104 and current requested motor effort is maintained. If yes, a determination is made whether the current temperature is greater than a second temperature threshold (step 108). If yes, the motor is shut down (step 110) and the method ends (step 112). If no at step 108, the current requested motor effort is reduced to set a new requested effort at step 114 and the method 100 returns to step 106. The method 100 will continue to cycle through steps 106, 108, and 114 so long as the temperature remains between the first and second thresholds. If the temperature drops below the first threshold (i.e., YES at step 106), the method proceeds back to step 104 and the requested effort can again be set based solely on trigger pull. If the temperature rises above the second threshold (i.e., YES at step 108), the motor will shut down at step 110.

In some implementations, the method 100 can be stored as steps in memory to be executed by the controller 12. In some implementations, this method 100 can be executed as a control loop, to be repeated once every time period, such as once every millisecond or another suitable time period, while the power tool 10 is on. For example, the method 100 can be repeated once every time period while a user is pressing the trigger 24. Accordingly, rather than the controller 12 operating the tool 30 solely based on trigger pull until the second (e.g., maximum) temperature threshold is reached and shutting down operation as a thermal protection mechanism, according to the method of FIG. 6, as motor temperature increases, the controller 12 can reduce power (e.g., below what would be indicated by trigger pull) in order to maintain motor temperature below the second temperature threshold and prolong operation before motor shutdown.

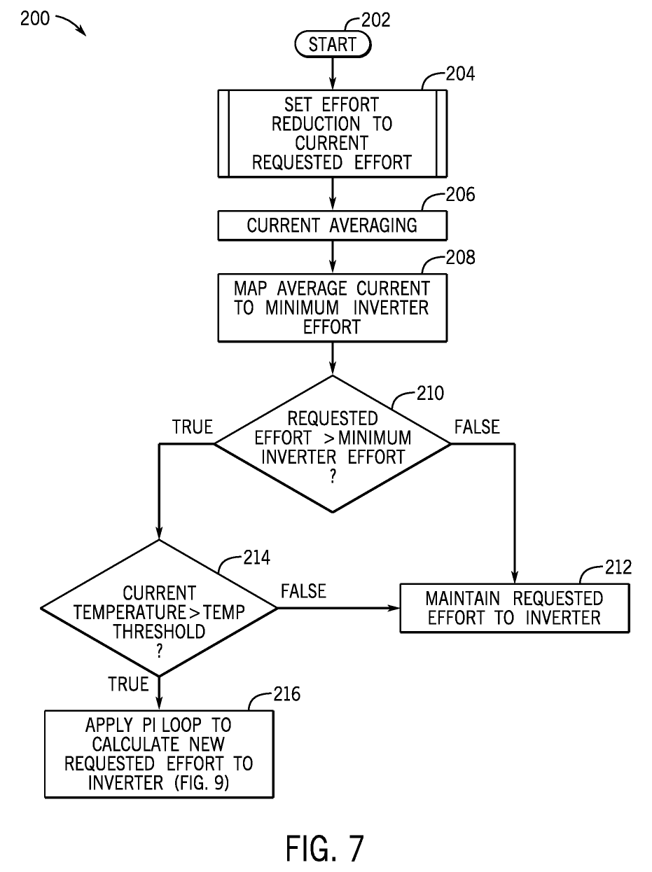

FIG. 7 illustrates a further example method 200 of such operation according to some implementations. Generally, as shown in FIG. 7, the method 200 is started (step 202), current requested motor effort is set (step 204), motor current is averaged over a time period (step 206), the average current is mapped to a minimum inverter effort (step 208), and a determination is made whether the requested motor effort is greater than the minimum inverter effort (step 210). If no, the current requested motor effort is maintained (step 212). If yes, a determination is made whether the current temperature is greater than a temperature threshold (step 214). If no, the current requested motor effort is maintained (step 210). If yes, a proportional-integral (PI) loop is applied to calculate a new requested motor effort (step 216).

In some implementations, the method 200 can be stored as steps in memory to be executed by the controller 12. In some implementations, this method 200 can be executed as a control loop, to be repeated once every time period, such as once every millisecond or another suitable time period, while the power tool 10 is on. For example, the method 200 can be repeated once every time period while a user is pressing the trigger 24. In other implementations, the method 200 can be repeated once every time period while a user is pressing the trigger 24, only when certain other criteria is met. Such other criteria may be, for example, a motor temperature threshold, a trigger press threshold, a speed threshold, a particular mode selection, or other suitable criteria.

Referring more specifically to the method 200 of FIG. 7, at step 202, the control loop is started. Inputs to this control loop can include motor temperature, current, and requested motor effort. For example, motor temperature can be estimated using a motor thermal model based on inputs from the thermistor on the sensor board 64, the hall sensors, and the current sensors, as described above. Alternatively, motor temperature can be directly obtained using a thermistor directly on motor coils. In yet other implementations, motor temperature can be estimated or derived using other methods or sensors. Current can be obtained from the current sensors (e.g., measured, amplified, and inverted current sense voltage from a current sensor in the form of a current sense resistor). Requested motor effort can be obtained based on current trigger travel. For example, as discussed above, requested motor effort can be a percentage of power applied to the inverter based on trigger travel, where trigger travel percentage is converted to a desired speed, which is then converted to requested motor effort that is calculated via a PI loop. Requested motor effort can be obtained based on current trigger travel via other methods in some implementations as well.

At step 204, current requested motor effort is set. Initially, the current requested motor effort can be based solely on trigger travel. However, the current requested motor effort can be updated following step 216, as further described below.

At step 206, motor current is averaged over a time period. For example, current values derived from the current sensor can be averaged over a set number of samples and/or a set time period. In one specific example, current can be averaged over a 100 millisecond (ms) time period; however, other timing or sample periods may be used in some implementations. Additionally, in some implementations, current can be averaged twice. For example, instantaneous current values from the current sensor can be obtained and averaged over a set number of samples, and those averaged values can be averaged over a 100-ms time period.

At step 208, the average current is mapped to a minimum inverter effort. That is, a map or chart can include current correlated inverter effort reduction so that the minimum effort can be obtained based on average current. As noted above, the purpose of the present method 200 can be to reduce motor effort in an attempt to avoid motor overheating or prolong operation before motor overheating. This mapping at step 208 can dynamically adjust the minimum inverter effort based on the existing current output of the power tool 10. For example, the minimum effort reduction can be set as an attempt to prevent the motor 16 from stalling.

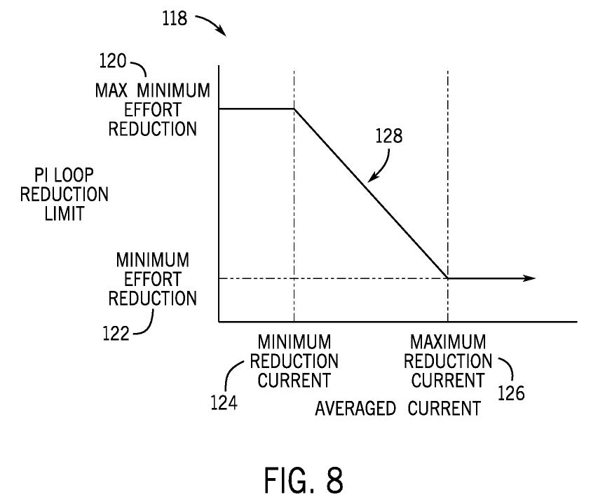

By way of example, FIG. 8 illustrates an example map 118 for use in step 208. FIG. 8 illustrates averaged current with respect to inverter reduction limits. The "max minimum effort reduction" value 120 is the maximum effort that inverter effort can be limited to. The "minimum effort reduction" value 122 is the minimum effort that the inverter effort can be limited to. The "minimum reduction current" 124 can be considered a lower current limit. The "maximum reduction current" 126 can be considered an upper current limit. Thus, for current values below and up to the minimum reduction current 124, the minimum inverter effort is set to the max value 120. For current values at and above the maximum reduction current 126, the minimum inverter effort is set to a minimum value 122. For current values between the minimum reduction current 124 and the maximum reduction current 126, the minimum inverter effort is set according to an inverse linear relationship 128, as shown in FIG. 8. The values for max minimum effort reduction 120, minimum effort reduction 122, minimum reduction current 124, and maximum reduction current 126 can be preset, for example, based on tool type, size, and/or other factors. Accordingly, at step 208, the average current is input and a minimum effort reduction is output based on the mapping.

At step 210, a determination is made whether the requested motor effort is greater than the minimum inverter effort. That is, the output from step 204 is compared to the output from step 208. If the requested effort is not greater than the minimum inverter effort (i.e., "FALSE" at step 210), then the method proceeds to step 212, in which the requested effort from step 204 is maintained and the motor 16 is driven at the requested effort. This same requested effort would again be used at step 204 when the method 200 is repeated, e.g., unless a user adjusts the trigger 24 or stops pressing the trigger 24.

If the requested effort is greater than the minimum inverter effort (i.e., "TRUE" at step 210), then the method proceeds to step 214, in which a determination is made whether the present temperature is greater than a temperature threshold. If no, (i.e., "FALSE" at step 214), the current requested motor effort is maintained (step 212). For example, the temperature threshold can be a preset temperature less than the maximum temperature threshold at which the motor 16 is shut down. Thus, if the present temperature is below the temperature threshold, the motor 16 is not at risk of approaching the maximum temperature threshold and, thus, there is no reason to reduce motor effort. However, if the output at step 214 is TRUE (i.e., the present temperature is greater than a temperature threshold), a proportional-integral (PI) loop is applied to calculate a new requested motor effort at step 216 in an attempt to reduce or maintain motor temperature below the maximum shut-off temperature threshold. This new requested motor effort would then be used to drive the motor 16 and, further, would be used at step 204 when the method 200 is repeated, e.g., unless a user adjusts the trigger 24 or stops pressing the trigger 24.

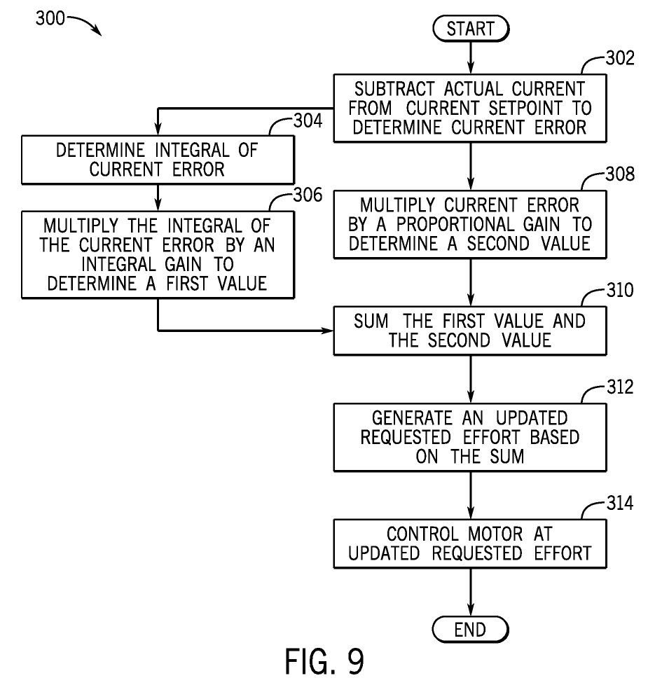

FIG. 9 illustrates an example PI loop 300 according to some implementations, which may be implemented at step 216 of FIG. 7, or step 114 of FIG. 6. As shown in FIG. 9, the PI loop 300 includes, at step 302, subtracting actual current from a current setpoint to determine a current error. At step 304, an integral of the current error is determined and, at step 306, the integral can be multiplied by an integral gain (e.g., a first predetermined gain value) to determine a first value (e.g., the integral component of the PI control output). At step 308, the current error can be multiplied by a proportional gain (e.g., a second predetermined gain value) to determine a second value (e.g., the proportional component of the PI control output). The first value and the second value can then be added together at step 310 and, at step 312, an updated requested inverter effort can be generated based on the sum of the first value and the second value (e.g., the sum of the proportional and integral components of the PI control output) as well as the minimum inverter effort. For example, the updated requested effort can be less than the current requested effort output at step 204 in, but more than the minimum inverter effort output at step 208. At step 314, power to the motor 16 can be provided based on the updated requested effort. Additionally, while the PI loop 300 is described herein with respect to current, other variables may be used in some implementations. For example, in one implementation, temperature may be used.

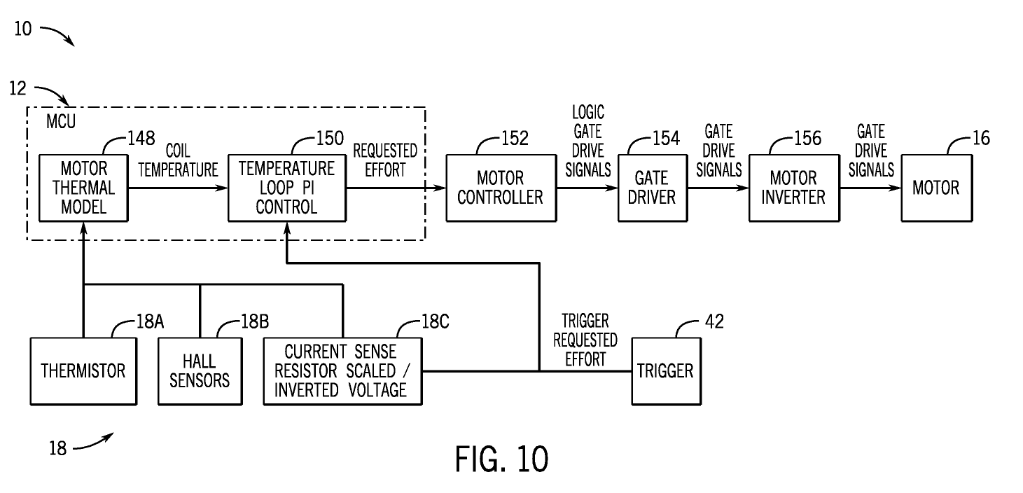

In light of the above, FIG. 10 illustrates a schematic diagram of tool components according to some implementations. As shown in FIG. 10, the controller 12 can receive, as inputs, information from sensors 18 including a thermistor 18A, hall sensors 18B, and current sensors 18C. The controller 12 can use the inputs from the sensors 18 to determine motor coil temperature based on a motor thermal model 148, though direct temperature sensing can be accomplished in some implementations (e.g., via a thermistor or other temperature sensor located directly on the motor coils). The motor coil temperature, sensed current from sensor 18C, and requested effort from the trigger 42 can be input to a temperature loop PI control 150, e.g., including methods 100, 300. The output of the temperature loop PI control 150 can be the updated requested motor effort, e.g., based on trigger pull alone or trigger pull and the PI loop 300, which can be input to a motor controller 152. The motor controller 152 can output logic gate drive signals to a gate driver 154, which can output gate drive signals to a motor inverter 156, which can apply the gate drive signals to the motor 16 to drive the motor 16.

Accordingly, in light of the above, the motor 16 can be driven at a lower speed than what the trigger pull calls for (e.g., a trigger pull that would normally results in 75% power to the inverter may result in a 50% power to the inverter as a result of the PI loop) when a first temperature threshold is reached (e.g., the first temperature threshold at step 106 in FIG. 6 or the temperature threshold at step 214 in FIG. 7). As a result of the motor 16 being driven at a lower power, motor temperature may be reduced. That is, the methods 100, 200, 300 herein can try to reduce power until motor temperature stabilizes or is reduced below a set temperature threshold, or until a minimum inverter effort is reached, in which the tool 10, 30 will continue operating at the minimum effort until the maximum temperature threshold (e.g., the second temperature threshold at step 108 in FIG. 6) is reached, in which the thermal protection mechanism stops the motor 16. For example, at any time during tool operation under the methods 100, 200, 300 in FIG. 6, FIG. 7, and FIG. 9, if the motor temperature reaches a second temperature threshold, e.g., the maximum temperature threshold, the controller 12 can automatically shut down the motor 16 according to the thermal protection mechanism. However, the methods 100, 200, 300 herein can reduce power applied to the inverter prior to motor shutdown, when the first temperature threshold is reached, in an attempt to recover thermals and extend motor operation prior to a required shutdown.

In some implementations, this motor power reduction according to the PI loop 300 can be felt by the user, thus providing feedback to the user that the tool 10 is attempting to continue operation despite motor temperature increasing. In further implementations, additional user feedback may be provided at this time. For example, when step 114 of FIG. 6 or step 216 of FIG. 7 is reached, the controller 12 may instruct one or more LEDs 72, 76 to light up and/or flash.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A power tool comprising: a motor; an inverter that drives the motor; a sensor configured to sense a variable indicative of a motor temperature of the motor; a trigger; a power source; and a controller in communication with the inverter, the sensor, the trigger, and the power source, the controller configured to: apply power from the power source to the inverter to drive the motor at a requested effort level based on an amount of travel of the trigger when the trigger is depressed, reduce the requested effort level to the inverter when the motor temperature reaches a first temperature threshold, and shut down the motor when the motor temperature reaches a second temperature threshold.

2. The power tool of claim 1, wherein the controller is further configured to maintain the requested effort level to the inverter when the first temperature threshold is reached if the requested effort level is less than a minimum effort level.

3. The power tool of claim 2, wherein the controller is further configured to determine the minimum effort level based on an average input current to the motor.

4. The power tool of claim 3, wherein the controller is further configured to determine the average input current to the motor based on input from the sensor.

5. The power tool of claim 1, wherein the controller is further configured to determine the motor temperature based on a thermal model calculated using inputs from the sensor.

6. The power tool of claim 5, wherein the sensor includes a thermistor located within a drive unit that houses the motor, a current sense resistor that senses input current to the motor, and a hall sensor that determines a speed of the motor.

7. The power tool of claim 1, wherein the sensor is a thermistor located on a coil of the motor,
and the controller is further configured to determine the motor temperature based on input from the sensor.

8. The power tool of claim 1, wherein the controller is configured to reduce the requested effort level using a proportional-integral control loop.

9. The power tool of claim 8, wherein the proportional-integral control loop uses motor current as an input variable.

10. The power tool of claim 8, wherein the proportional-integral control loop uses motor temperature as an input variable.

11. A method of operating a power tool, the method comprising: applying power from a power source to an inverter to drive a motor at a requested effort level based on an amount of travel of a trigger when the trigger is depressed; reducing the requested effort level to the inverter when a motor temperature of the motor reaches a first temperature threshold; and shutting down the motor when the motor temperature reaches a second temperature threshold.

12. The method of claim 11, further comprising maintaining the requested effort level to the inverter when the first temperature threshold is reached if the requested effort level is less than a minimum effort level.

13. The method of claim 12, further comprising determining the minimum effort level based on an average input current to the motor.

14. The method of claim 13, wherein determining the minimum effort level based on the average input current to the motor includes using a map of average input current to minimum effort level according to a type of the power tool.

15. The method of claim 14, wherein the map limits the minimum effort level between a minimum value and a maximum value.

16. The method of claim 14, wherein the map provides an inverse relationship between the average input current and the minimum effort level.

17. The method of claim 11, further comprising determining the motor temperature based on a thermal model calculated using inputs from a thermistor located within a drive unit that houses the motor, a current sense resistor that senses input current to the motor, and a hall sensor that determines a speed of the motor.

18. The method of claim 11, further comprising obtaining the motor temperature from a thermistor located on a coil of the motor.

19. The method of claim 11, wherein reducing the requested effort level to the inverter includes reducing the requested effort level to the inverter using a proportional-integral control loop.

20. A method of operating a power tool, the method comprising: applying power from a power source to an inverter to drive a motor at a requested effort level based on an amount of travel of a trigger when the trigger is depressed; determining a minimum effort level based on an input current to the motor; comparing the requested effort level to the minimum effort level; and reducing the requested effort level to the inverter when a motor temperature of the motor reaches a first temperature threshold and the requested effort level is greater than the minimum effort level.
